(19) United States
(12) Patent Application Publication
(10) Pub. No.: US 2017/0307186 A1
(43) Pub. Date: Oct. 26, 2017

(54) LIGHTING ASSEMBLY WITH MOVABLE OPTIC FOR LIGHT POLE

(71) Applicant: Lighting Science Group Corporation, Cocoa Beach, FL (US)

(72) Inventors: Eric Bretschneider, Bowling Green, KY (US); Fredric S. Maxik, Cocoa Beach, FL (US); David E. Bartine, Cocoa, FL (US); Addy S. Widjaja, Palm Bay, FL (US); Ran Zhou, Rockledge, FL (US); Theodore Scone, Satellite Beach, FL (US)

(73) Assignee: Lighting Science Group Corporation, Cocoa Beach, FL (US)

(21) Appl. No.: 15/494,238

(22) Filed: Apr. 21, 2017

Related U.S. Application Data
(60) Provisional application No. 62/327,697, filed on Apr. 26, 2016.

(51) Int. Cl. F21V 17/02; F21V 14/04; F21V 7/00; F21V 17/10; F21S 8/08

(52) U.S. Cl. CPC F21V 17/02; F21V 17/107; F21S 8/086; F21V 7/0025; F21V 14/04

(57) ABSTRACT

A lighting assembly comprising a light source operable to emit light, a first primary optic, and a second primary optic. Each of the first primary optic and the second primary optic are configured so as to reflect light incident thereupon to be emitted by the lighting assembly. Additionally, each of the first primary optic and the second primary optic are positioned such that a first portion of light emitted by the light source is incident upon the first primary optic and a second portion of light emitted by the light source is incident upon the second primary optic. At least one of the first primary optic and the second primary optic is operable to me rotated to change the relative position thereof with respect to the light source.

### RELATED APPLICATIONS

This application claims the benefit under 35 U.S.C. §119(e) of U.S. Provisional Patent Application Ser. No. 62/327,697 filed on Apr. 26, 2016 and titled Lighting Assembly With Movable Optic for Light Pole, the entire content of which is incorporated herein by reference

### FIELD OF THE INVENTION

The present invention relates to lighting assemblies for light poles that include a movable optic to alter the distribution of light emitted by the assembly.

### BACKGROUND

Tailoring light distribution from light poles has historically either been non-existent (e.g. only a single distribution is offered) or must be determined upon installation, or even upon placing an order for pole lights, as a limited number of lighting assemblies to be used in pole lights with pre-defined and set distributions and lighting characteristics are available. Such limitations often result in inferior lighting of the desired area or delays in project completion due to ordering incorrect lighting assemblies or ordering in the wrong quantities. Moreover, once installed, changing the light emission distribution of a given light pole requires the ordering of a new lighting assembly, coming at significant cost and delay. Accordingly, there is a need in the art for a lighting assembly that can have its light emission distribution changed at the time of installation or any point thereafter.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a lighting assembly comprising a light source operable to emit light, a first primary optic, and a second primary optic. Each of the first primary optic and the second primary optic are configured so as to reflect light incident thereupon to be emitted by the lighting assembly. Additionally, each of the first primary optic and the second primary optic may be positioned such that a first portion of light emitted by the light source is incident upon the first primary optic and a second portion of light emitted by the light source is incident upon the second primary optic. Furthermore, at least one of the first primary optic and the second primary optic may be operable to me rotated to change the relative position thereof with respect to the light source.

In some embodiments, the lighting assembly may further comprise a rotation assembly. Each of the first primary optic and the second primary optic may be carried by the rotation assembly, and the rotation assembly may be operable to rotate at least one of the first primary optic and the second primary optic to change the relative position thereof with respect to the light source. Furthermore, the rotation assembly may be operable to rotate each of the first primary optic and the second primary optic to change the relative positions thereof with respect to the light source. Additionally, the rotation assembly may be operable to rotate each of the first primary optic and the second primary optic independently of the other. The rotation assembly may comprise a hinge.

In some embodiments, the rotation assembly may be operable to rotate the first primary optic in a first direction and the second primary optic in a second direction that is different from the first direction. Additionally, the rotation of the first primary optic and the second primary optic may result in a symmetric configuration of the first primary optic and the second primary optic about a longitudinal axis of the lighting assembly.

In some embodiments, the rotation assembly may comprise a manipulation member that is accessible so as to be operated by a user outside the lighting assembly. The manipulation member may be operable to cause the rotation assembly to rotate at least one of the first primary optic and the second primary optic. Additionally, the lighting assembly may further comprise an outer housing and the rotation assembly may further comprise an optic interfacing member configured to interface with each of the first primary optic and the second primary optic and an extension member connected at one end to the optic interfacing member and at another end to the manipulation member. The manipulation member may be positioned outside the outer housing and the optic interfacing member is positioned inside the outer housing. Furthermore, at least one of the first primary optic and the second primary optic may comprise an interfacing surface configured to interface with the optic interfacing member. The rotation assembly may be configured such that vertical translation thereof may cause the interface between the optic interfacing member and the interfacing surface to cause the at least one of the primary optic and the second primary optic to rotate.

In some embodiments, the rotation of at least one of the first primary optic and the second primary optic results in a change of a distribution of light emitted by the lighting assembly. At least one of the first primary optic and the second primary optic may be formed of a reflective material and/or comprise a reflective material applied to a surface thereof. At least one of the first primary optic and second primary optic may comprise a reflective surface having a concave geometry and/or a reflective surface having an eccentric geometry.

In some embodiments, the lighting assembly may further comprise a secondary optic. Each of the first primary optic and the second primary optic may be configured to reflect light incident thereupon in the direction of the secondary optic. Additionally, a proportion of light emitted by the light source in the direction of the first primary optic and the second primary optic may exceed the proportion of light emitted by the light source in the direction of the secondary optic.

In some embodiments, at least one of the first primary optic and the second primary optic may comprise a fixation section comprising a plurality of openings configured to permit a pin to be positioned therethrough.

### BRIEF DESCRIPTION OF THE DRAWINGS

FIG. 1 is a top perspective view of a lighting assembly according to an embodiment of the invention.

FIG. 2 is a lower plan view of the lighting assembly of FIG. 1.

FIG. 3 is a lower plan view of the lighting assembly of FIG. 1 with a secondary optic thereof removed.

FIG. 4 is a lower perspective view of the lighting assembly of FIG. 1 with the secondary optic removed.

FIG. 5 is a perspective view of a rotation mechanism of the lighting assembly of FIG. 1.

FIG. 6 is a front elevation view of the rotation mechanism of the lighting assembly of FIG. 1.

FIG. 7 is a lower plan view of the rotation mechanism of the lighting assembly of FIG. 1.

FIG. 8 is a sectional view of the lighting assembly of FIG. 1 taken through line 8-8 in FIG. 1.

FIG. 9 is an optic for a lighting assembly according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a lighting assembly for a light pole. The lighting assembly may comprise an optic that is operable to be positioned to change the distribution of light emitted by the lighting assembly. More specifically, the optic may be operable to change the angle of distribution of light, selectively narrowing or broadening the beam angle.

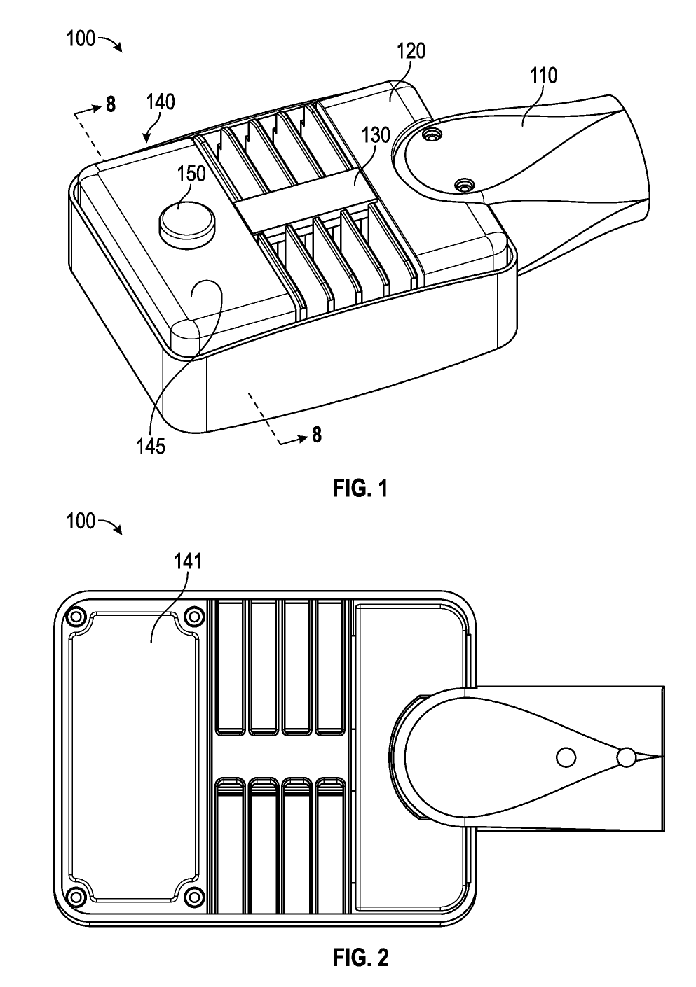

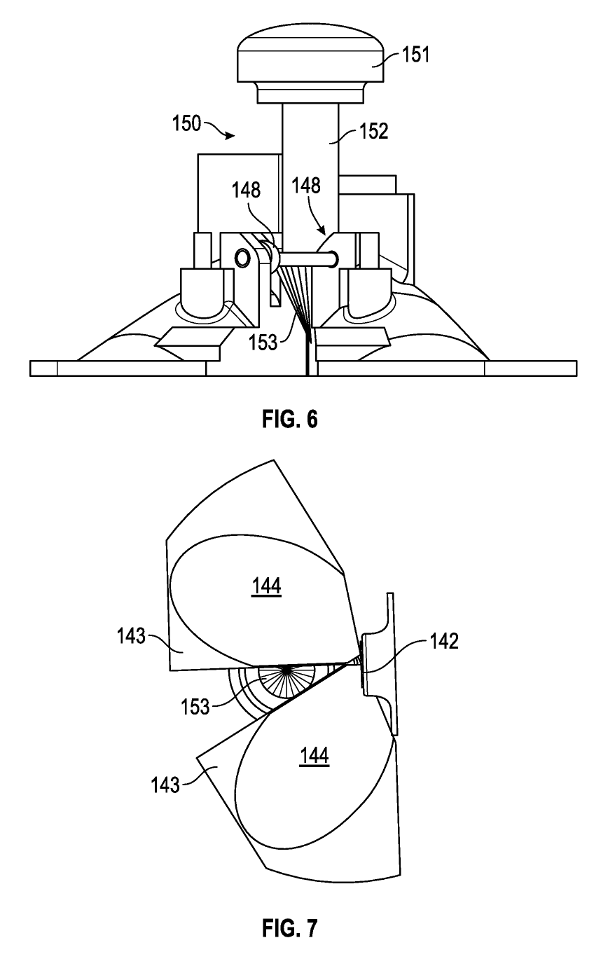

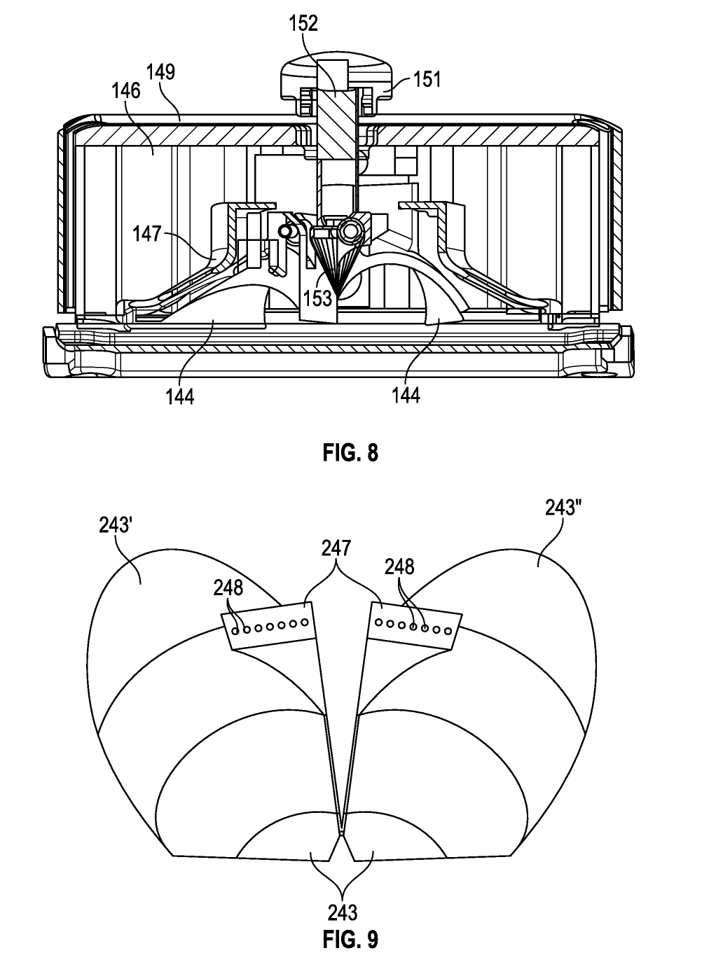

Referring now to FIGS. 1-8, a lighting assembly 100 according to an embodiment of the invention is presented. The lighting assembly 100 is related to the invention disclosed in U.S. patent application Ser. No. 14/703,809 titled Modular Streel Lighting System filed May 4, 2015, the content of which is incorporated by reference herein in its entirety, to the extent disclosure therein is consistent with disclosure herein. Additionally, the content of U.S. Pat. No. 8,702,259 titled Color Conversion Occlusion and Associated Methods issued Apr. 22, 2014 is incorporated herein by reference, to the extent disclosure there is consistent with disclosure herein.

The lighting assembly 100 may comprise a rear attachment section 110, a circuitry housing 120, a body member 130, and a lighting section 140. The rear attachment section 110 may be configured to attach to at least one of a light pole and a structure attached to a light pole that is configured to attach to the rear attachment section, and further be configured to permit electrical wiring associated with the light pole to pass through the rear attachment section to the circuitry housing 120. The circuitry housing 120 may be configured to permit circuitry to be housed therein that is electrically connected to each of electrical wiring positioned through the rear attachment section 110 and with a light source that includes the lighting section 140. Furthermore, the body member 130 may be configured to permit electrical wiring to pass therethrough to enable electrical connection between a light source of the lighting section 140 and circuitry housed within the circuitry housing 120. Additional details regarding the rear attachment section 11, circuitry housing 120, and body member 130 may be found in U.S. patent application Ser. No. 14/703,809 referenced hereinabove.

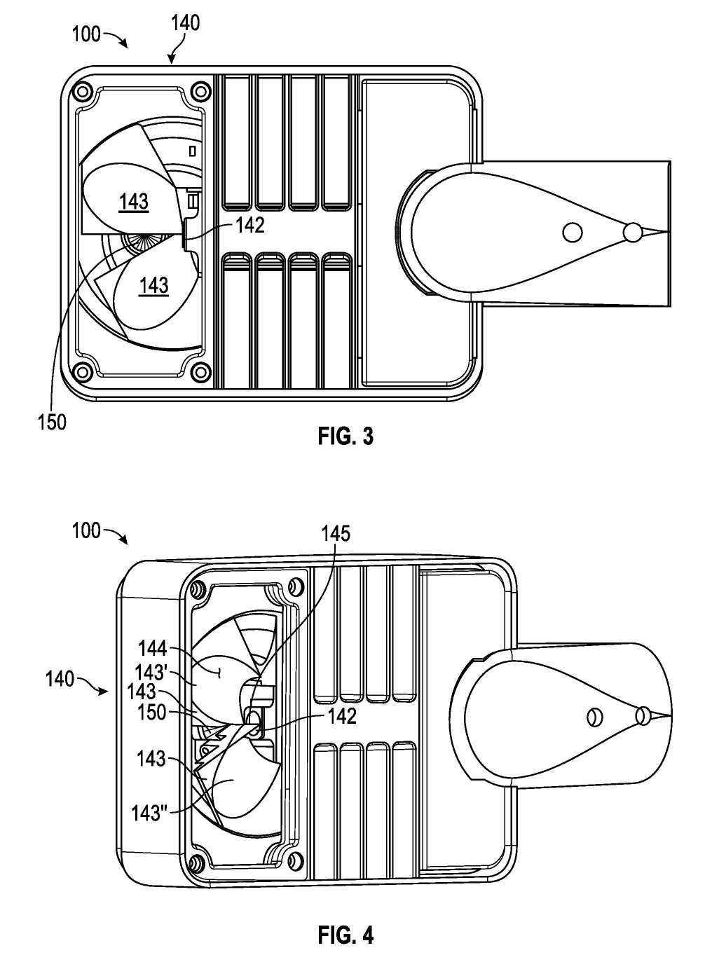

The lighting section 140 may comprise a secondary optic 141 positioned such that all light emitted by the lighting assembly 100 passes therethrough. As is best illustrated in FIGS. 2 and 3, the lighting section 140 may further comprise a light source 142, at least one primary optic 143, and a rotation assembly 150. The at least one primary optic 143 may be configured to reflect, refract, or otherwise redirect light in the direction of the secondary optic 141. While the present embodiment comprises two primary optics 143, any number of primary optics is contemplated and included within the scope of the invention.

In the present embodiment, the lighting section 140 comprises a first primary optic 143′ and a second primary optic 143″. The light source 142 may be positioned such that light emitted thereby is incident upon each of the first and second primary optics 143′, 143″. More specifically, the light source may be positioned such that a first portion of light emitted thereby is incident upon the first primary optic 143′ and that a second portion of light emitted thereby is incident upon the second primary optic 143″. Each of the first and second primary optics 143′, 143″ may be configured to redirect light in the direction of the secondary optic 141. The first and second primary optics 143′, 143″ may be formed of a reflective material or may have a reflective coating applied to define a reflective surface 144. The reflective surface 144 may have a geometry that results in the redirection of light in the direction of the secondary optic 141. In the present embodiment, the reflective surface 144 has a generally concave geometry. Moreover, the reflective surface 144 may have a generally eccentric geometry.

The at least one primary optic 143 may be carried by the rotation assembly 150. The rotation assembly 150 may be operable to be manipulated by a user so as to change the relative position of the at least one primary optic 143 respective to the light source 142. In the present embodiment, operation of the rotation assembly 150 may result in the rotation of each of the first and second primary optics 143′, 143″ about a rotational axis. In some embodiments, the rotational axis may be defined by a hinge 145. As can be seen in FIG. 5, each of the first and second primary optics 143′, 143″ may comprise a hinge attachment section 160 configured to facilitate attachment to the hinge 145 so as to enable the rotation of the primary optics 143 about the hinge 145. The first primary optic 143′ may rotate in one direction, and the second primary optic 143″ may rotate in another direction that may be opposite the rotation direction of the first primary optic 143′.

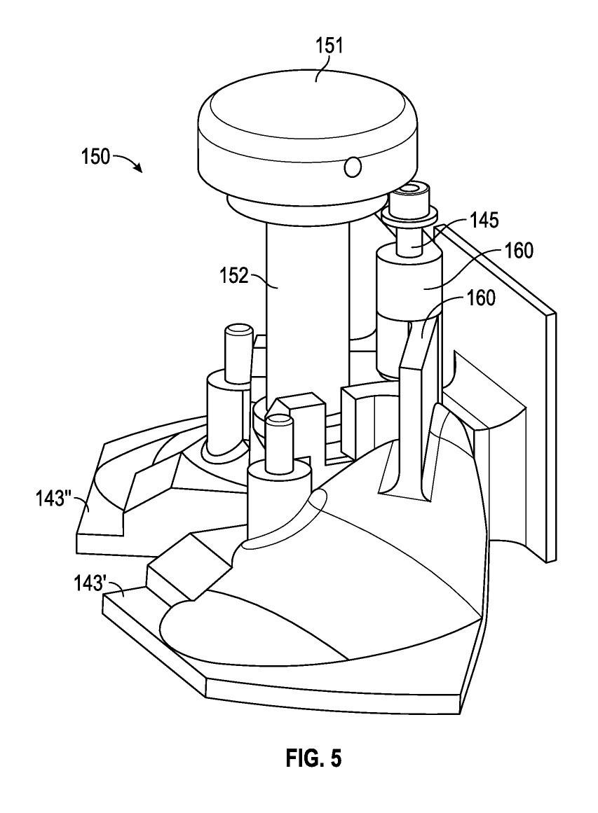

The eccentric geometry of the reflective surface 144 result in light being reflected thereby to result in a different distribution of light emitted by the lighting assembly 100 when the primary optic 143 comprising the reflective surface 144 is moved with respect to the light source 142. As shown in FIGS. 3 and 4, for example, the first primary optic 143′ is in a first position relative to the light source 142 resulting in a first distribution of light emitted by the lighting assembly 100 on a side of the longitudinal axis of the lighting assembly 100 associated with the first primary optic 143′. Additionally, the second primary optic 143″ may be in a second position relative to the light source 142 resulting in a second distribution of light emitted by the lighting assembly 100 on a side of the longitudinal axis of the lighting assembly 100 associated with the second primary optic 143″. The second distribution may be different than the first distribution. In some embodiments, the first and second primary optics 143′, 143″ may be positioned such that their positioning results in a symmetric configuration about the longitudinal axis of the lighting assembly 100 or an asymmetric configuration, as shown in FIGS. 3 and 4. When positioned to be in a symmetric configuration, the first and second distributions of light emitted from sides of the longitudinal axis of the lighting assembly 100 may be similarly symmetric.

Referring now specifically to FIGS. 5-8, aspects of the rotational assembly 150 will now be discussed in greater detail. The rotation assembly 150 may be configured to be operable by a user. The rotation assembly 150 may comprise a manipulation member 151, an extension member 152, and an optic interfacing member 153. The rotation assembly 150 may be positioned such that the manipulation member 151 may be accessible by a user outside the lighting assembly 100. In the present embodiment, the manipulation member 151 is located extending from an upper section of the lighting section 140. Specifically, the manipulation member 151 may extend upward from an upper section of an outer housing 149 of the lighting section, as can be seen in FIG. 1. The outer housing 149 may be configured to permit the rotation assembly 150 to pass therethrough. More specifically, the extension member 152 may be connected at one end and extend downward from the manipulation member 151, through an aperture of the outer housing 149, through an aperture of an inner housing 146 of the lighting section 140, and through an aperture of a tertiary optic 147 of the lighting section 140. The optic interfacing member 153 may extend downward from a lower end of the extension member 152 and be configured to interface with an interfacing surface 148 of the first and second primary optics 143′, 143″. Moreover, the optic interfacing member 153 may be configured to taper to an end point at a lower end thereof.

In the present embodiment, the at least one of the primary optics 143 and the hinge 145 may comprise a biasing member (not shown) that is biased to cause each of the first and second primary optics 143′, 143″ to be rotated towards one another and away from a distal end of the lighting section. In the present embodiment, the biasing member may be biased to cause the first primary optic 143′ to rotate in a counterclockwise direction and the second primary optic to rotate in a clockwise direction. The interfacing between the optic interfacing member 153 and the interfacing surface 148 of the first and second primary optics 143′, 143″ may cause the first and second primary optics 143′, 143″ to rotate. The direction of rotation may depend on the manner in which the rotation assembly 150 is operated. In the present embodiment, the manipulation member 151 is operable to be translated vertically up and down, resulting in concordant translations up and down by the extension member 152 and the optic interfacing member 153. Due to the tapered configuration of the optic interfacing member 153, as the optic interfacing member 153 translates downward, it will interface with the interfacing surfaces of the first and second primary optics 143′, 143″ and cause them to rotate in a direction opposite the rotation caused by the biasing member, namely, clockwise for the first primary optic 143′, and counterclockwise for the second primary optic 143″, by applying a force to the first and second primary optics 143′, 143″ that is greater than the force applied by the biasing member.

Conversely, as the optic interfacing member 153 translates upward, the magnitude of the force applied thereby to the first and second primary 143′, 143″ optics is reduced, permitting them to rotate in the direction caused by the biasing member, namely, permitting the first primary optic 143′ to rotate counterclockwise and the second primary optic 143″ to rotate clockwise. When the manipulation member 151 is operated so as to be positioned at its further position upward, the first and second primary optics 143′, 143″ may be positioned so as to reflect light emitted by the light source 142 resulting in a narrowest distribution of light. Conversely, when the manipulation member 151 is operated so as to be positioned at its further position downward, the first and second primary optics 143′, 143″ may be positioned so as to reflect light emitted by the light source 142 resulting in a widest distribution of light.

In order to secure the rotational position of the first and second primary optics 143′, 143″, the manipulation member 151 may be operable to lock in place, preventing the upward or downward motion of the manipulation member, and by extension the optic interfacing member 153. In the present embodiment, turning the manipulation member 151 in one direction may engage a locking mechanism or feature (not shown) thereof, thereby preventing such up or down translation.

This method of imparting rotation to the primary optics 143 is exemplary only, and any other method of imparting such rotation is contemplated and included within the scope of the invention.

The light source 142 may be any light-emitting device as is known in the art, including, but not limited to, an incandescent filament, a halogen light source, a fluorescent light source, a xenon light source, and a light-emitting semiconductor, including light-emitting diodes (LEDs). Types of LEDs that are contemplated include, but are not limited to, LED arrays, LED dies, and multiple LED diodes, arrays, and multiple individual LEDs. In the present embodiment, the light source 142 comprises a single LED array configured as a chip-on-board.

The light source 142 may be positioned such that a substantial portion, approaching and including all, light emitted thereby is emitted in the direction of at least one of the at least one primary optic 143 and the secondary optic 141. In some embodiments, the portion of light emitted by the light source 142 in the direction of the at least one primary optic, more specifically the total light emitted to multiple primary optics 143, may significantly exceed the portion of light emitted in the direction of the secondary optic 141. In this way the distribution of light emitted by the lighting assembly 100 may be more significantly controlled by the positioning of the at least one primary optic 143.

Referring now to FIG. 9, another embodiment of first and second primary optics 243′, 243″ is presented. In the present embodiment, the first and second primary optics 243′, 243″ may be substantially similar to the first and second primary optics 143′, 143″ depicted in FIGS. 1-8, but comprise a fixation section 247. The fixation section 247 may be configured to facilitate the fixing of the first and second primary optics 243′, 243″ in a position relative to one another. Specifically, the fixation section 247 may comprise a plurality of openings 248 which may permit a pin to be positioned therethrough, the pin also being positioned through an interstitial member (not shown) such that, when a first pin is positioned through an opening 248 comprised by the fixation section 247 of the first primary optic 243′ and the interstitial member and a second pin is positioned through an opening 248 comprised by the fixation section 247 of the second primary optic 243″ and the interstitial member, the relative positioning between the first and second primary optics 243′, 243″ may be fixed, such that one may not translate, rotationally or otherwise, without the other also translating and, in some embodiments, preventing movement of the first and second primary optics 243′, 243″ altogether. In such an embodiment, the rotation member 150 as described hereinabove may be omitted from a lighting assembly. Moreover, the first and second primary optics 243′, 243″ may exclude the hinge attachment sections 160, as there is no hinge to attach to.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A lighting assembly comprising:
a light source operable to emit light;
a first primary optic; and
a second primary optic;
wherein each of the first primary optic and the second primary optic are configured so as to reflect light incident thereupon to be emitted by the lighting assembly;
wherein each of the first primary optic and the second primary optic are positioned such that a first portion of light emitted by the light source is incident upon the first primary optic and a second portion of light emitted by the light source is incident upon the second primary optic; and
wherein at least one of the first primary optic and the second primary optic is operable to me rotated to change the relative position thereof with respect to the light source.

2. The lighting assembly of claim 1 further comprising a rotation assembly; wherein each of the first primary optic and the second primary optic are carried by the rotation assembly; and wherein the rotation assembly is operable to rotate at least one of the first primary optic and the second primary optic to change the relative position thereof with respect to the light source.

3. The lighting assembly of claim 2 wherein the rotation assembly is operable to rotate each of the first primary optic and the second primary optic to change the relative positions thereof with respect to the light source.

4. The lighting assembly of claim 3 wherein the rotation assembly is operable to rotate each of the first primary optic and the second primary optic independently of the other.

5. The lighting assembly of claim 2 wherein the rotation assembly comprises a hinge.

6. The lighting assembly of claim 2 wherein the rotation assembly is operable to rotate the first primary optic in a first direction and the second primary optic in a second direction that is different from the first direction.

7. The lighting assembly of claim 6 wherein the rotation of the first primary optic and the second primary optic results in a symmetric configuration of the first primary optic and the second primary optic about a longitudinal axis of the lighting assembly.

8. The lighting assembly of claim 2 wherein the rotation assembly comprises a manipulation member that is accessible so as to be operated by a user outside the lighting assembly: and wherein the manipulation member is operable to cause the rotation assembly to rotate at least one of the first primary optic and the second primary optic.

9. The lighting assembly of claim 8 further comprising an outer housing;
wherein the rotation assembly further comprises
an optic interfacing member configured to interface with each of the first primary optic and the second primary optic; and
an extension member connected at one end to the optic interfacing member and at another end to the manipulation member; and
wherein the manipulation member is positioned outside the outer housing and the optic interfacing member is positioned inside the outer housing.

10. The lighting assembly of claim 9 wherein at least one of the first primary optic and the second primary optic comprises an interfacing surface configured to interface with the optic interfacing member; and wherein the rotation assembly is configured such that vertical translation thereof may cause the interface between the optic interfacing member and the interfacing surface to cause the at least one of the primary optic and the second primary optic to rotate.

11. The lighting assembly of claim 1 wherein the rotation of at least one of the first primary optic and the second primary optic results in a change of a distribution of light emitted by the lighting assembly.

12. The lighting assembly of claim 1 wherein at least one of the first primary optic and the second primary optic is formed of a reflective material.

13. The lighting assembly of claim 1 wherein at least one of the first primary optic and the second primary optic comprise a reflective material applied to a surface thereof.

14. The lighting assembly of claim 1 wherein at least one of the first primary optic and second primary optic comprise a reflective surface having a concave geometry.

15. The lighting assembly of claim 1 wherein at least one of the first primary optic and the second primary optic comprise a reflective surface having an eccentric geometry.

16. The lighting assembly of claim 1 further comprising a secondary optic; wherein each of the first primary optic and the second primary optic are configured to reflect light incident thereupon in the direction of the secondary optic.

17. The lighting assembly of claim 16 wherein a proportion of light emitted by the light source in the direction of the first primary optic and the second primary optic exceeds the proportion of light emitted by the light source in the direction of the secondary optic.

18. The lighting assembly of claim 1 wherein at least one of the first primary optic and the second primary optic comprises a fixation section comprising a plurality of openings configured to permit a pin to be positioned therethrough.

19. A lighting assembly comprising:
a light source operable to emit light;
a rotation assembly;
a first primary optic carried by the rotation assembly;
a second primary optic carried by the rotation assembly; and
a secondary optic;
wherein each of the first primary optic and the second primary optic are configured so as to reflect light incident thereupon in the direction of the secondary optic;
wherein each of the first primary optic and the second primary optic have a concave and eccentric geometry;
wherein each of the first primary optic and the second primary optic are positioned such that a first portion of light emitted by the light source is incident upon the first primary optic and a second portion of light emitted by the light source is incident upon the second primary optic; and
wherein the rotation assembly is operable to rotate each of the first primary optic and the second primary optic to change the relative position thereof with respect to the light source resulting in a symmetric configuration about a longitudinal axis of the lighting assembly.

20. The lighting assembly of claim 19 further comprising an outer housing, wherein the rotation assembly further comprises
a manipulation member;
an optic interfacing member configured to interface with each of the first primary optic and the second primary optic; and
an extension member connected at one end to the optic interfacing member and at another end to the manipulation member; and
wherein the manipulation member is positioned outside the outer housing and the optic interfacing member is positioned inside the outer housing;
wherein the manipulation member is operable to cause the rotation assembly to rotate at least one of the first primary optic and the second primary optic.
